(19) United States
(12) Patent Application Publication
(10) Pub. No.: US 2026/0268803 A1
(43) Pub. Date: Sep. 10, 2026

(54) ANATOMIC SIMULACRA WITH REINFORCED HOLE

(71) Applicant: Arthrex, Inc., Naples, FL (US)

(72) Inventors: Michael Moreland, Fort Myers, FL (US); David Knopf, Bonita Springs, FL (US); Shervin Kazemi, Naples, FL (US); Benjamin D. Bernarding, Naples, FL (US)

(73) Assignee: Arthrex, Inc., Naples, FL (US)

(21) Appl. No.: 19/559,747

(22) Filed: Mar. 6, 2026

Related U.S. Application Data
(60) Provisional application No. 63/888,829, filed on Sep. 26, 2025.
(60) Provisional application No. 63/768,250, filed on Mar. 7, 2025.

(51) Int. Cl. G09B 23/34; B33Y 80/00

(52) U.S. Cl. CPC G09B 23/34; B33Y 80/00

(57) ABSTRACT

An anatomic simulacra includes at least one reinforced hole defined through the anatomic simulacra. The at least one reinforced hole includes a bore and a reinforcement area proximate the bore. A kit for performing a surgical training procedure includes the anatomic simulacra.

### CROSS-REFERENCE TO RELATED APPLICATIONS

This application priority to and the benefit of U.S. Provisional Application No. 63/768,250 filed on Mar. 7, 2025 and U.S. Provisional Application No. 63/888,829 filed on Sep. 26, 2025. The disclosures of the above applications are incorporated herein by reference.

### BACKGROUND

The present disclosure relates to medical devices for surgical training, and more particularly relates to anatomic simulacra with at least one reinforced hole.

Generally, surgical procedures may be practiced using a cadaver specimen. Cadaver specimens, however, require refrigeration along with special handling and disposal. Cadaver specimens may also have inconsistent quality due to freezing and thawing cycles, and the bone density may vary. Further, the mounting of cadaver specimens to practice a surgical procedure may be limited due to the nature of the particular cadaver specimen. In addition, it may be difficult to repeatedly practice certain surgical techniques, such as suturing, on cadaver specimens.

### SUMMARY

This section provides a general summary of the disclosure and is not a comprehensive disclosure of its full scope or all of its features.

The present disclosure provides a polymer-based synthetic specimen or anatomic simulacra. The anatomic simulacra permits one or more surgical procedures to be practiced for training purposes. The anatomic simulacra is formed using additive manufacturing techniques, such as three-dimensional (3D) printing or may be cast.

In one example, the anatomic simulacra includes at least one reinforced hole which permits the performance of a surgical training procedure. By reinforcing the at least one hole, the surgical training procedure may be performed or practiced multiple times without replacing the anatomic simulacra. In addition, providing a reinforcement area about a bore or hole strengthens the hole, which inhibits an inadvertent tearing of the hole during the surgical training procedure.

In one example, anatomic simulacra is provided. The anatomic simulacra includes at least one reinforced hole defined through the anatomic simulacra. The at least one reinforced hole includes a bore and a reinforcement area proximate the bore.

The anatomic simulacra is a polymer-based synthetic ligament, muscle or tendon. The at least one reinforced hole includes a plurality of reinforced suture holes, which are defined through the anatomic simulacra to extend from a first surface to a second surface. The reinforcement area includes at least one of a material characteristic, a material or combinations thereof that is different than a remainder of the anatomic simulacra. The material characteristic is at least one of a density, an additive manufacturing print pattern, a durometer and a thickness. The material is a textile fiber reinforcement. The material is a non-elastomeric polymer-based material. The material is an elastomeric polymer-based material. The anatomic simulacra is additively manufactured, and the reinforcement area is integrally formed with the synthetic specimen. The at least one reinforced hole is discretely formed and coupled to the anatomic simulacra. The reinforcement area is defined about at least a portion of a perimeter of the bore. The anatomic simulacra includes an external thread, and the reinforcement area is defined within at least a portion of the thread to surround at least a portion of the bore. The reinforcement area is defined at a terminal end of the bore.

Also provided is a kit for performing a surgical training procedure. The kit includes at least one ligament anatomic simulacra having a first end opposite a second end and a first surface opposite a second surface. The at least one ligament anatomic simulacra defines at least one reinforced hole through the first surface and the second surface. The kit includes an anatomic simulacra configured to be coupled to the at least one ligament anatomic simulacra with the at least one reinforced hole.

The kit includes a second anatomic simulacra that cooperates with the anatomic simulacra to form a synthetic anatomical joint. The at least one ligament anatomic simulacra is coupled to the second anatomic simulacra at the second end, and the at least one reinforced hole is defined proximate the first end. The kit includes a suture, and the suture is configured to couple the first end of the at least one ligament anatomic simulacra to the anatomic simulacra. The at least one ligament anatomic simulacra is a polymer-based synthetic ligament, muscle or tendon. The at least one reinforced hole comprises a plurality of reinforced suture holes. The at least one reinforced hole comprises a bore and a reinforcement area substantially surrounding the bore. The reinforcement area includes at least one of a material characteristic, a material or combinations thereof that is different than a remainder of the at least one synthetic tissue specimen. The material characteristic is at least one of a density, an additive manufacturing print pattern, a durometer and a thickness. The material is a textile fiber reinforcement. The at least one ligament anatomic simulacra is additively manufactured, and the reinforcement area is integrally formed with the at least one ligament anatomic simulacra. The at least one reinforced hole is discretely formed and coupled to the at least one ligament anatomic simulacra.

Further areas of applicability will become apparent from the description provided herein. It should be understood that the description and specific examples are intended for purposes of illustration and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1A is a schematic illustration of a surgical environment.

FIG. 1B is a schematic illustration of a surgical system.

FIG. 2 is a perspective view of an exemplary anatomic simulacra, which includes at least one reinforced hole according to the various teachings of the present disclosure, which may be within the surgical environment and utilized by the surgical system.

FIG. 3 is an environmental view of the anatomic simulacra of FIG. 2, which is coupled at one end to a bone anatomic simulacra.

FIG. 4 is a cross-sectional view of the anatomic simulacra of FIG. 2, taken along line 3-3 of FIG. 2.

FIG. 5 is an environmental view of the anatomic simulacra of FIG. 2, which is coupled to a pair of bone anatomic simulacra upon the completion of an exemplary surgical training procedure.

FIG. 6 is a cross-sectional view of another exemplary anatomic simulacra which includes at least one reinforced hole, taken along the perspective of line 3-3 of FIG. 2.

FIG. 7 is a front view of an exemplary anatomic simulacra, which includes at least one reinforced hole according to the various teachings of the present disclosure.

FIG. 8 is a perspective view of the anatomic simulacra of FIG. 7.

FIG. 9 is a perspective view of an exemplary anatomic simulacra, which includes at least one reinforced hole according to the various teachings of the present disclosure.

FIG. 10 is a front view of the anatomic simulacra of FIG. 9.

The drawings described herein are for illustration purposes and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. In addition, there is no intention to be bound by any expressed or implied theory presented in the preceding introduction, brief summary or the following detailed description.

As described, the present disclosure provides a polymer-based synthetic anatomical specimen or anatomic simulacra for surgical training having at least one reinforced hole. The anatomic simulacra may be used in the place of a cadaveric specimen. The anatomic simulacra may be tailored to the anatomy of various patients, which enables a surgical trainee to practice a surgical procedure on different anatomical models. In addition, the anatomic simulacra may enable a predefined suturing procedure to be practiced, which may be difficult to practice otherwise. It should be noted that while the anatomic simulacra is described herein as being used to practice a portion of a surgical procedure, such as suturing, it should be understood that the anatomic simulacra may also be used to practice a surgical training procedure that simulates a surgical procedure, and thus, the present disclosure is not limited to practicing suturing. In addition, it should be noted that a “trainee” may comprise any suitable individual and/or a robot 27, and the use of the term “trainee” is not intended to limit the scope of this disclosure.

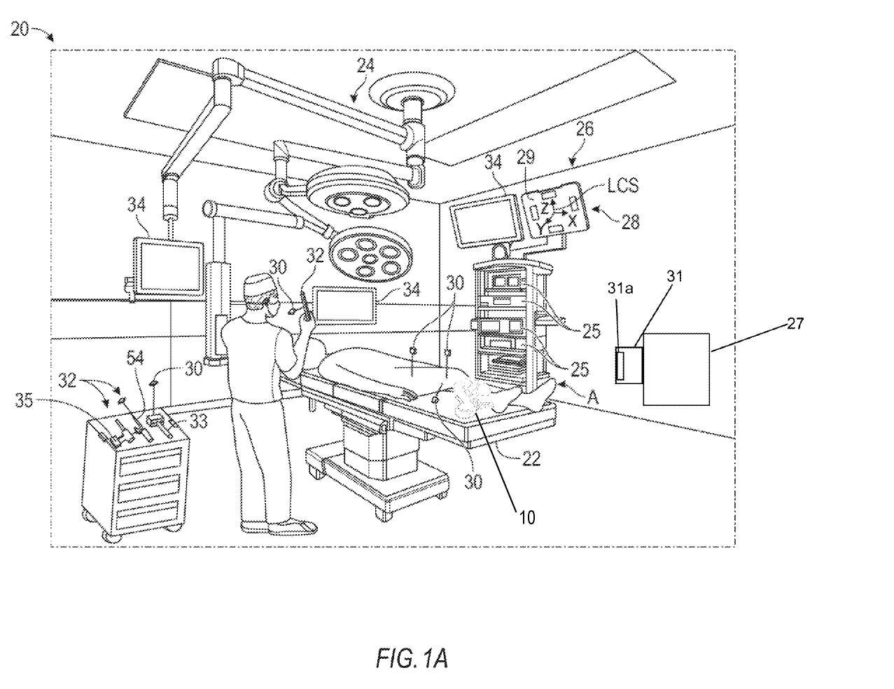

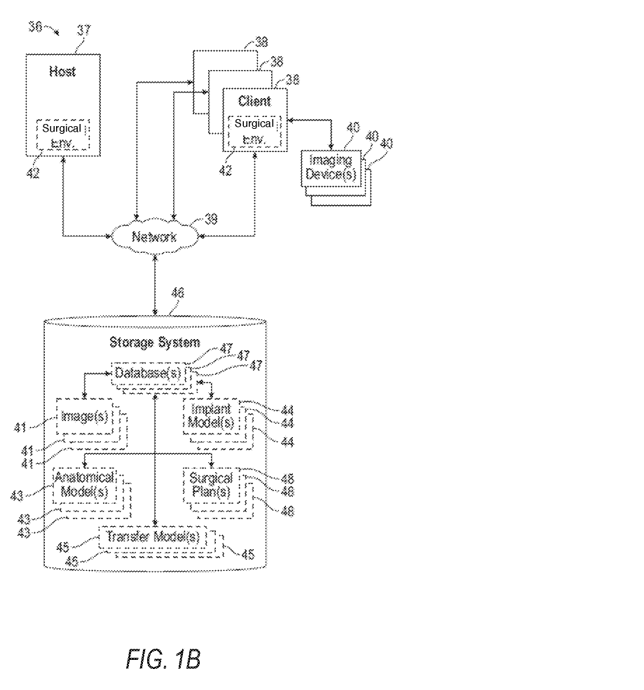

FIG. 1A may provide a surgical suite (e.g., system or assembly) 20 according to an implementation. The surgical suite 20 may be utilized to perform various surgical procedures (e.g., manual surgical procedures, robotic-assisted surgical procedures, surgical training procedures), including but not limited to, an orthopedic procedure such as an arthroscopy or an arthroplasty to restore functionality to one or more bones and/or joints. The surgical procedure may include repair of one or more bone pathologies (e.g., defects) associated with a bone of a patient. The surgical procedure may include repair of one or more soft tissues such as a damaged muscle, ligament, tendon or the like. The suite 20 may be utilized in the repair of various locations of the anatomy and other surgical procedures including repair of other bones and joints such as the shoulder, foot, ankle, wrist, hand, hip, knee, and spine. The suite 20 may also be used in a surgical training procedure to repair an anatomic simulacra 10. The anatomic simulacra 10 may include a ligament anatomic simulacra 100, a first bone anatomic simulacra 102, a second bone anatomic simulacra 104, an anatomic simulacra 300 and/or an anatomic simulacra 400 described below.

The suite 20 may include an operating table 22 for supporting an anatomy A of a patient and/or the anatomic simulacra 10 as will be described below. The suite 20 may include a light assembly 24, which may include one or more light sources for communicating light towards the patient anatomy A and/or the anatomic simulacra 10.

The suite 20 may include one or more computing devices 25. The computing device(s) 25 may include (e.g., processing) circuitry, including one or more processors coupled to memory, input devices, and/or output devices. The processor(s) may be collectively operable to perform any of the functionality disclosed herein. The computing device(s) 25 may be operable to establish a surgical plan and/or implement the surgical plan for treating the patient. The computing device(s) 25 may be operable to establish a surgical training procedure involving the anatomic simulacra 10.

The suite 20 may include an equipment tower 26. The equipment tower 26 may include one or more modules (e.g., systems), which may incorporate the computing device(s) 25. The module(s) may include a guidance (e.g., navigation or tracking) module 28. The guidance module 28 may include a localizer 29, which may be operatively coupled to the computing device(s) 25. The localizer 29 may include a sensor unit having one or more sensors. One or more trackers 30 may be situated (e.g., fixed or secured) relative to the patient anatomy A and/or the anatomic simulacra 10. The trackers 30 may comprise an anatomy tracker. The trackers 30 may include one or more objects (e.g., markers). The trackers 30 may include active devices (e.g., sensors or light emitting diodes) and/or passive devices (e.g., reflectors). The tracker(s) 30 may be placed relative to the anatomy A, the anatomic simulacra 10 and/or one or more surgical devices (e.g., instruments) 32. The devices 32 may include any of the devices disclosed herein. The devices 32 may include one or more surgical guides 33, cutting instruments 35, and/or surgical probes 54. The tracker(s) 30 may be placed relative to one or more landmarks of the anatomy A and/or the anatomic simulacra 10. The surgeon or clinical user may manipulate the surgical devices 32 during a surgical procedure. The localizer 29 may be operable to determine (e.g., track) the position and/or orientation of the trackers 30. The guidance module 28 may be operable to determine the position and/or orientation of each tracker 30 with respect to a (e.g., localizer or global) coordinate system (e.g., framework) LCS of the localizer 29. The suite 20 may be operable to transfer coordinates in the coordinate system LCS to another coordinate system (e.g., framework), such as a local coordinate system of a surgical device 32 or a coordinate system associated with a surgical planning system, and/or vice versa, using various transformation techniques.

The suite 20 may include one or more displays 34. The computing device(s) 25 may be operable to cause the display(s) 34 to display various data and/or information associated with a patient, including a surgical plan and/or guidance information. A surgeon or clinical user may interact with the display(s) 34. The guidance module 28 may be operable to cause the display(s) 34 to display a position and/or orientation of the tracker(s) 30 and/or associated surgical device(s) 32 relative to the anatomy A of the patient and/or the anatomic simulacra 10.

The suite 20 may include the robot 27, which may be in communication with the computing devices 25. The computing devices 25 may be operable to control the robot 27. In some examples, the computing devices 25 may cause the robot 27 to perform a portion or all of a surgical procedure or surgical training procedure. In some examples, the computing devices 25 may be used to control the robot 27 to evaluate one or more characteristics of the patient and/or target anatomy. In other examples, the computing devices 25 may be operable to validate a movement of the robot 27 relative to the anatomic simulacra 10.

The robot 27 may be used to assist with and/or perform a surgical procedure, a training procedure, or both. In some examples, the robot 27 may be a hand-held robot. In some other examples, the robot 27 may include a robotic arm 31. The robot 27 may include a base and an end effector 31a operatively coupled with the base. The robot 27 may include one or more actuators to move the end effector 31a, the base, or both. The end effector 31a may comprise a working end of the robot 27, and may include a proximal portion to be operatively coupled to the base, and a distal portion that includes a surgical instrument or tool. The distal portion of the end effector 31a may include, but is not limited to, a burr, a drill, a probe, a saw, a medical device, a measuring device, one or more sensors, a microscope, a camera, a light, an endoscope, an ultrasound probe, an irrigation device, a suction device, a radiotherapy device, and/or any other instrument or tool useful for surgery, surgical planning, and/or surgical navigation. In one example, the anatomic simulacra 10 may be used to validate or verify an accuracy of a movement of the robotic arm 31 prior to the performance of the surgical procedure.

FIG. 1B may provide a surgical (e.g., planning or guidance) system (e.g., assembly) 36 according to an implementation. The surgical suite 20 may incorporate and/or may interface with the surgical system 36. The surgical system 36 may be utilized for planning and/or executing orthopedic and/or other surgical procedures, including pre-operatively, intra-operatively and/or post-operatively to create, edit, execute and/or review surgical plans. The surgical system 36 may be utilized for various orthopedic and other surgical procedures, including any of the procedures disclosed herein. The surgical system 36 may be utilized in the design and/or placement of various surgical constructs (e.g., devices). Surgical constructs may include any item assembled and/or placed in the patient anatomy A and/or the anatomic simulacra 10 during surgery to repair, place and/or support tissue. Surgical constructs may include grafts and implants such as an implant incorporated into a prosthesis and/or surgical instruments such as a transfer guide for positioning one or more surgical instruments, implants and/or grafts. The grafts may include synthetic and/or biological materials, such as an allograft or autograft. The systems and methods disclosed herein may be utilized in the repair of various locations of the anatomy and various surgical procedures including repair of bones and joints associated with the anatomy A and/or the anatomic simulacra 10 such as the shoulder, foot, ankle, wrist, hand, hip, knee and spine. The surgical system 36 may be utilized to perform other orthopedic procedures, including sports medicine procedures which may be performed to repair and/or reconstruct ligament(s) and/or tendon(s) and which may include use of graft(s). Sports medicine procedures may include a rotator cuff repair and anterior cruciate ligament (ACL) and/or posterior cruciate ligament (PCL) repairs.

The surgical system 36 may include a host computer 37 and one or more client computers 38. The host computer 37 may be configured to execute one or more software programs. In implementations, the host computer 37 may be more than one computer jointly configured to process software instructions serially and/or in parallel. The computing device(s) 25 of the surgical suite 20 (FIG. 1A) may include and/or may interface with the computer(s) 37, 38. Further, the robot 27 may interface with the computers 37, 38.

The computers 37, 38 may be operable to communicate with one or more networks such as a network 39 comprised of one or more computing devices. The network 39 may be a private local area network (LAN), a private wide area network (WAN), the Internet, or a mesh network.

The host computer 37 and each client computer 38 may include one or more computer processors, memory, storage means, network devices, and input and/or output devices and/or interfaces. The input devices may include keyboards, mice and touch screens. The output devices may include monitors, speakers and printers. The memory may include UVPROM, EEPROM, FLASH, RAM, ROM, DVD, CD, a hard drive, or other computer readable medium which may store data and/or other information relating to the planning and implementation techniques disclosed herein. The computer processor(s) may be operable to individually and/or collectively execute any of the functionality disclosed herein.

The host computer 37 and each client computer 38 may be a desktop computer, laptop computer, smart phone, tablet, wearable (e.g., augmented reality) device, or any other computing device. The interface may be adapted to facilitate communication with the other systems and/or components of the network 39, including the various modules of the surgical suite 20 (FIG. 1A).

Each client computer 38 may be operable to communicate with the host computer 37 directly via a direct client interface or over the network 39. In another implementation, the client computers 38 may be operable to communicate with each other directly via a peer-to-peer interface.

The surgical system 36 may include, or may interface with, one or more imaging devices 40. The host computer 37 and/or client computer(s) 38 may be coupled to the imaging device(s) 40. Each imaging device 40 may be configured to capture or acquire imagery, including one or more images 41 of patient anatomy A and/or the anatomic simulacra 10 that may reside within a scan field (e.g., window) of the imaging device 40. The imagery may include two-dimensional (2D) and/or three-dimensional (3D) greyscale and/or color images 41. Various imaging devices 40 may be utilized, such as an X-ray machine, CT machine or MRI machine that may be operable to obtain one or more images of the anatomy A of the patient and/or the anatomic simulacra 10.

The client computers 38 may be operable to execute one or more software programs, including programs for controlling various surgical tools, which may include the robot 27. Each client computer 38 may be operable to access and locally and/or remotely execute a surgical (e.g., planning or guidance) environment 42. The surgical environment 42 may be a standalone software package or may be incorporated into another surgical tool. The surgical environment 42 may be configured to communicate with the host computer 37 either over the network 39 or directly through the direct client interface. In implementations, the host computer 37 may be operable to execute the surgical environment 42.

The surgical environment 42 may be operable to obtain (e.g., acquire) imagery of patient anatomy A and/or the anatomic simulacra 10, including one or more images 41. The surgical environment 42 may be operable to interact with one or more of the imaging devices 40 to capture, acquire or otherwise obtain image(s) 41 of patient anatomy A and/or the anatomic simulacra 10. The surgical environment 42 may be operable to provide a display (e.g., visualization) of one or more images 41, virtual anatomical (e.g., bone) models 43, and/or surgical device models including virtual surgical construct (e.g., implant or graft) models 44 and/or virtual surgical transfer (e.g., instrument or guide) models 45 via one or more graphical user interfaces (GUI). The anatomical model 43 may be representative of one or more bones and/or soft tissue, which may be associated with a respective joint. Each image 41, anatomical model 43, implant model 44, transfer model 45 and/or other data and information may be stored in one or more files or records according to a specified data structure. The implant model 44 may include one or more components. The implant model 44 may be associated with various implants, such as bases (e.g., base plates or trays) configured to be coupled to a respective articulation member, and bone plates configured to interconnect adjacent bones or bone fragments. The articulation member may have an articular surface dimensioned to mate with an articular surface of an opposed bone or implant. As described below, the client computers 38 may execute one or more software programs defined by the surgical environment 42.

The surgical system 36 may include at least one storage system 46, which may be operable to store or otherwise provide data to other computing devices. The storage system 46 may be a storage area network device (SAN) configured to communicate with the host computer 37 and/or the client computers 38 over the network 39. In implementations, the storage system 46 may be incorporated within, or may be directly coupled to, the host computer 37 and/or client computers 38. The storage system 46 may be configured to store various information, such as one or more computer software instructions, data, database files and configurations. In implementations, the storage system 46 may be remote (e.g., server or cloud-based storage) from the host computer 37 and/or client computers 38. The storage system 46 may be connected with the host computer 37 and/or client computers 38 through a network connection which may be wired or wireless.

In implementations, the surgical system 36 may be a client-server architecture configured to execute computer software on the host computer 37, which may be accessible by the client computers 38 using either a thin client application or a web browser executing on the client computers 38. The host computer 37 may be operable to load the computer software instructions from local storage, or from the storage system 46, into memory and may execute the computer software using the one or more computer processors. Other architectures may be utilized, including cloud computing.

The surgical system 36 may include one or more databases 47. The databases 47 may be stored at a central location, such as the storage system 46. In other implementations, one or more databases 47 may be stored at the host computer 37 and/or may be a distributed database provided by one or more of the client computers 38. Each database 47 may be a relational database configured to associate one or more images 41, anatomical models 43, implant models 44 and/or transfer models 45 to each other and/or a respective surgical plan(s) 48. Each surgical plan 48 may be associated with the anatomy of a respective patient and/or the anatomic simulacra 10. Each image 41, anatomical model 43, implant model 44, transfer model 45 and/or surgical plan 48 may be assigned a unique identifier or database entry. The database 47 may be configured to store data and other information corresponding to the images 41, anatomical models 43, implant models 44, transfer models 45 and/or surgical plans 48 in one or more database records or entries, and/or may be configured to link or otherwise associate one or more files corresponding to each respective image 41, anatomical model 43, implant model 44, transfer model 45 and/or surgical plan 48. Images 41, anatomical models 43, implant models 44, transfer models 45 and/or associated surgical plans 48 stored in the database(s) 47 may correspond to respective patient anatomies, the anatomic simulacra 10 from prior, planned and/or hypothetical surgical cases, and may be arranged into one or more predefined categories such as sex, age, race, ethnicity, defect category, procedure type, surgeon, and/or facility or organization.

Each image 41 and/or anatomical model 43 may include data and other information obtained from one or more medical devices or tools, such as the imaging devices 40. The anatomical model 43 may include coordinate information relating to an anatomy of the patient, the anatomic simulacra 10 obtained or derived from image(s) 41 captured or otherwise obtained by the imaging device(s) 40. Each implant model 44 and transfer model 45 may include geometry and/or coordinate information associated with a predefined design or a design established or modified by the surgical environment 42. The surgical environment 42 may incorporate and/or interface with one or more modeling packages, such as a computer aided design (CAD) package, to render the models 43, 44, 45 as 2D and/or 3D volumes or constructs, which may overlay one or more of the images 41 in a display window (e.g., screen) of a GUI.

The anatomical (e.g., bone or joint) model(s) 43 and/or implant model(s) 44 may be associated with a local coordinate (e.g., reference) system and/or a global (e.g., common) coordinate (e.g., reference) system. The surgical environment 42 may define the global coordinate system utilizing any of suitable technique. The global coordinate system may be associated with a set of coordinate values. The global coordinate system may include the localizer coordinate system LCS (FIG. 1A). In implementations, the global coordinate system may be representative of an anatomical position of the patient and/or the anatomic simulacra 10, which may be the same or may differ from an acquisition position associated with the image data which may be acquired by the imaging device(s) 40. The global coordinate system may be established with respect to Z (0, 0, 1), Y (0, 1, 0) and X (1, 0, 0) axes. The Z axis of the global coordinate system may correspond to a vertical direction. The X and Y axes of the global coordinate system may extend in respective horizontal directions along a horizontal plane. The global coordinate system may be established relative to one or more anatomical planes of the anatomy A and/or the anatomic simulacra 10. An orientation of the anatomical model(s) 43 relative to the global coordinate system may be representative of an anatomical (e.g., upright or vertical) position of the patient, or an anatomical position of the anatomic simulacra 10. The axes of the local and/or global coordinate systems may be established with respect to an acquisition orientation of the imagery associated with the imaging device(s) 40. The surgical environment 42 may be operable to register the anatomical model(s) 43 associated with the anatomy of a patient and/or the anatomic simulacra 10 from the respective local coordinate system to the global coordinate system. The surgical environment 42 may be operable to evaluate and/or display the anatomical model(s) 43 with respect to the local and/or global coordinate system, including establishing a surgical plan 48 and/or performing a range of motion simulation, which may be associated with one or more implant model(s) 44 placed relative to the anatomical model(s) 43.

The implant models 44 may correspond to (e.g., physical) implants and components of various configurations, shapes, sizes, procedures and/or instrumentation. The implant model 44 may be associated with a patient-specific implant for treating a single patient or particular patient associated with the anatomic simulacra 10, or may be non-patient specific (e.g., generic) for treating different patients or generic ones of the anatomic simulacra 10. Each implant may include, or may otherwise be associated with, one or more components that may be situated at a surgical site including grafts and various fixation devices such as screws, anchors, nails and suture. Each implant model 44 may correspond to a single (e.g., monolithic) component or may include two or more components that may be configured to establish an assembly. The implant model 44 may include a base (e.g., base plate or tray) coupled to an articulation member, bone plates configured to interconnect adjacent bones or bone fragments, intermedullary nails and/or suture anchors. The articulation member may have an articular surface dimensioned to mate with an articular surface of an opposed bone or implant. The implant(s), instrument(s) and/or associated component(s) may be formed of various materials, including metallic and/or non-metallic materials. Each anatomical model 43, implant model 44 and transfer model 45 may correspond to 2D and/or 3D geometry and may be utilized to generate a wireframe, mesh and/or solid construct in a display.

The transfer model(s) 45 may be associated with respective transfer devices. The transfer devices may include configurable (e.g., reusable), patient-specific and/or procedure specific devices. The transfer devices may include guides, which may be adapted to guide one or more surgical devices, including guide elements (e.g., K-wires and pins) and/or cutting instruments 35.

Each surgical plan 48 may be associated with one or more of the images 41, anatomical models 43, implant models 44 and/or transfer models 45. The surgical plan 48 may include various parameters associated with the respective images 41, anatomical models 43, implant models 44 and/or transfer models 45. The parameters may relate to bone characteristics (e.g., bone density and/or bone quality) associated with patient anatomy A and/or the anatomic simulacra 10 captured in the image(s) 41. The surgical plan 48 may include parameters including spatial information relating to relative placement and coordinate information of the selected anatomical model(s) 43, implant model(s) 44 and/or transfer model(s) 45.

The surgical plan 48 may include one or more revisions to an anatomical (e.g., bone, joint, and/or the anatomic simulacra 10) model 43 and/or information relating to placement of an implant model 44 and/or transfer model 45 relative to the original and/or revised anatomical model 43. The surgical plan 48 may include coordinate information relating to the revised anatomical model 43 and a relative placement of the implant model 44 and/or transfer model 45 in predefined data structure(s). The surgical environment 42 may be operable to make one or more revisions to a transfer model 45 automatically or in response to user interaction with the user interface. Revisions to the anatomical model 43, implant model 44, transfer model 45 and/or surgical plan 48 may be stored in the database 47 automatically and/or in response to user interaction with the system 36.

One or more surgeons and other clinical users may be provided with a surgical environment 42 via the client computers 38 and may simultaneously access the image(s) 41, anatomical model(s) 43, implant model(s) 44, transfer model(s) 45 and/or surgical plan(s) 48 stored in the database(s) 47. Each user may interact with the surgical environment 42 to create, view, edit (e.g., modify) and/or approve various aspects of the surgical plan 48. Each client computer 38 may be configured to store local instances of the images 41, anatomical models 43, implant models 44, transfer models 45 and/or surgical plans 48, which may be synchronized in real-time or periodically with the database(s) 47. The surgical environment 42 may be a standalone software package executed on a client computer 38 or may be provided as one or more services executed on the host computer 37.

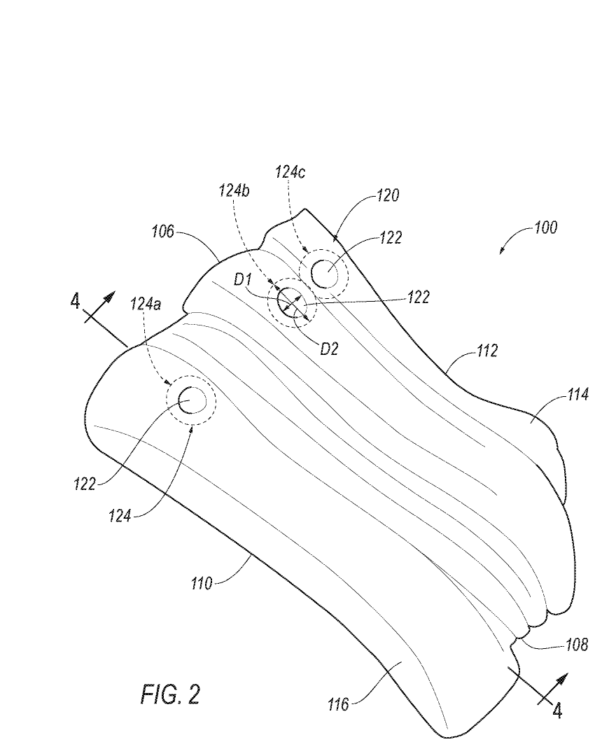

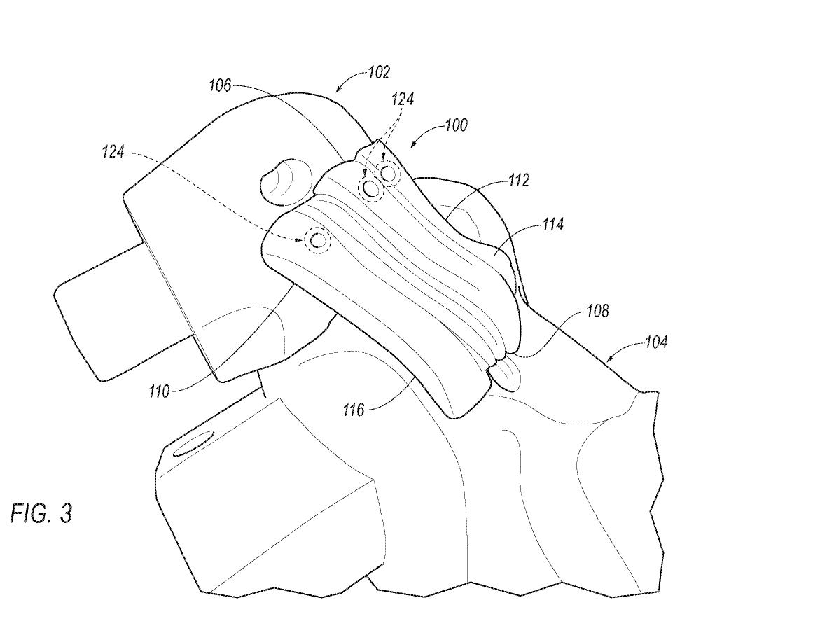

In one example, with reference to FIG. 2, the exemplary synthetic specimen, synthetic tissue specimen or ligament anatomic simulacra 100 is shown. In one example, with additional reference to FIG. 3, the ligament anatomic simulacra 100 may comprise a synthetic ligament for interconnecting the first synthetic anatomical structure, first synthetic bone or first bone anatomic simulacra 102 to the second synthetic anatomical structure, second synthetic bone or second bone anatomic simulacra 104, but in other examples, the ligament anatomic simulacra 100 may comprise a tendon, muscle, or the like. The ligament anatomic simulacra 100, the first bone anatomic simulacra 102 and the second bone anatomic simulacra 104 may be an anatomical synthetic specimen of a portion of a human or animal anatomy. It should be noted that while the ligament anatomic simulacra 100, the first bone anatomic simulacra 102 and the second bone anatomic simulacra 104 are described herein as comprising anatomic simulacra of a portion of a human or animal anatomy, the ligament anatomic simulacra 100, the first bone anatomic simulacra 102 and the second bone anatomic simulacra 104 may also be described as anatomical synthetic specimens. The ligament anatomic simulacra 100, the first bone anatomic simulacra 102 and the second bone anatomic simulacra 104 may be used in the place of a cadaveric specimen. In one example, the first bone anatomic simulacra 102 and the second bone anatomic simulacra 104 may comprise a synthetic anatomical joint.

The ligament anatomic simulacra 100, the first bone anatomic simulacra 102 and the second bone anatomic simulacra 104 may be constructed using additive manufacturing techniques and systems, such as three-dimensional (3D) printing. In other examples, the ligament anatomic simulacra 100, the first bone anatomic simulacra 102 and the second bone anatomic simulacra 104 or portions thereof may be cast. Thus, it should be understood that other manufacturing processes, including other additive manufacturing (AM) techniques, may be employed to form the ligament anatomic simulacra 100, the first bone anatomic simulacra 102 and the second bone anatomic simulacra 104.

In one example, the ligament anatomic simulacra 100, the first bone anatomic simulacra 102 and/or the second bone anatomic simulacra 104 may be formed using vat photopolymerization (VPP), in which ultraviolet (UV) light may be used to cure liquid photopolymer resins. For example, the UV light may cure the photopolymer resin layer by layer, and a platform may move as more layers are built on top of one another, within a build tray. It should be understood, however, that other 3D printing processes, or additive manufacturing (AM) techniques, may be employed while remaining within the scope of the present disclosure. The ligament anatomic simulacra 100, the first bone anatomic simulacra 102 and the second bone anatomic simulacra 104 may be composed of a predetermined mixture of polymer-based materials, and the ligament anatomic simulacra 100, the first bone anatomic simulacra 102 and the second bone anatomic simulacra 104 may be constructed with predetermined fill patterns or densities to have different characteristics to simulate different human or animal anatomical structures. In one example, the ligament anatomic simulacra 100, the first bone anatomic simulacra 102 and the second bone anatomic simulacra 104 may be composed of suitable polymer-based materials, including, but not limited to silicon, urethane, photopolymer resins, etc.

In this example, the ligament anatomic simulacra 100 may comprise a first end 106 opposite a second end 108, a first side 110 opposite a second side 112, a first surface 114 opposite a second surface 116 and at least one or a plurality of reinforced suture holes 120. The first end 106 may be coupled to the first bone anatomic simulacra 102, and the second end 108 may be coupled to the second bone anatomic simulacra 104. The first end 106 and the second end 108 may be somewhat irregular to simulate an end of an anatomical ligament. In one example, the first end 106 may not be fixedly attached to the first bone anatomic simulacra 102 and may include the plurality of reinforced suture holes 120 to couple the ligament anatomic simulacra 100 to the first bone anatomic simulacra 102 to provide surgical training. The second end 108 may be fixedly attached to the second bone anatomic simulacra 104 and may be devoid of the plurality of reinforced suture holes 120. In other examples, the second end 108 may include the plurality of reinforced suture holes 120 instead of the first end 106, such that the first end 106 may be fixedly attached to the second bone anatomic simulacra 104 while the second end 108 may be unattached for surgical training. In other examples, both the first end 106 and the second end 108 may each include the plurality of reinforced suture holes 120 such that the first end 106 and the second end 108 may be unattached to the respective one of the first bone anatomic simulacra 102 and the second bone anatomic simulacra 104 and may be reattached to provide for surgical training.

The first side 110 may interconnect the first end 106 and the second end 108, and the second side 112 may interconnect the first end 106 and the second end 108. The first side 110 and the second side 112 may each span a portion of the first bone anatomic simulacra 102 and a portion of the second bone anatomic simulacra 104. The first surface 114 may face the trainee, and the second surface 116 may contact respective portions of the first bone anatomic simulacra 102 and the second bone anatomic simulacra 104. The first surface 114 and the second surface 116 may include striations to simulate an appearance of a ligament.

As described, the plurality of reinforced suture holes 120 are defined proximate or at the first end 106 to couple the ligament anatomic simulacra 100 to the first bone anatomic simulacra 102. In this example, each of the plurality of reinforced suture holes 120 may define a bore 122 and a reinforcement area 124. The reinforcement area 124 may surround the bore 122 to provide strength to the bore 122 during the surgical training. The reinforcement area 124 may enable multiple surgical training procedures to be performed without requiring replacement of the ligament anatomic simulacra 100.

In this example, each bore 122 is defined or formed in the ligament anatomic simulacra 100 during the additive manufacture of the ligament anatomic simulacra 100. Each of the bores 122 are generally circular and may be defined to extend from the first surface 114 to the second surface 116. Each of the bores 122 may be defined so as to be spaced apart along the first end 106 with the spacing that may be desired during a suturing procedure for attaching a tissue, such as a ligament, to a bone in the field.

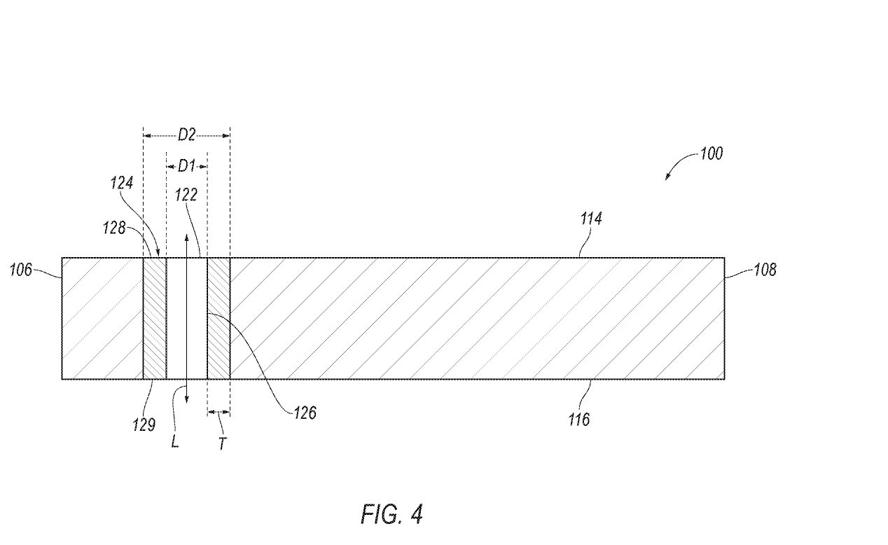

It should be noted that while the bores 122 may be illustrated herein as being substantially circular, the bores 122 may not be uniform and may have any predetermined polygonal shape depending upon the portion of the anatomy the ligament anatomic simulacra 100 is simulating. For example, with brief reference to FIG. 4, one or more of the bores 122 may have a diameter that varies along a central or longitudinal axis L of the bore 122. In other examples, a sidewall 126 of one or more of the bores 122 may be non-uniform and may include a draft angle or the like at or proximate the second surface 116. In other examples, the sidewall 126 may be wavy, include protuberances, or be angled relative to the longitudinal axis L. Thus, generally, while illustrated herein as being substantially circular, one or more of the bores 122 may have any predetermined shape to correspond with and conform to the portion of the anatomy simulated by the ligament anatomic simulacra 100. In addition, one or more of the bores 122 associated with the ligament anatomic simulacra 100 may be different from other ones of the bores 122, and may have a different sidewall 126, a different shape, a different height, etc. to conform the ligament anatomic simulacra 100 to the portion of the anatomy the ligament anatomic simulacra 100 is simulating.

In other examples, one or more of the bores 122 may be defined using a surgical instrument, such as a suture passer, to enable the trainee to practice the formation of the bore 122. In the example of the one or more of the bores 122 being formed with a surgical instrument during the surgical training procedure, the one or more of the bores 122 may be composed of a material that is substantially the same as the material of ligament anatomic simulacra 100 outside of the reinforcement area 124.

In FIGS. 1, 2 and 4, the reinforcement area 124 is illustrated with dashed lines as generally, the reinforcement area 124 blends into the material of the ligament anatomic simulacra 100. Stated another way, the reinforcement areas 124 may be integrally formed with or additively manufactured with the ligament anatomic simulacra 100 and may not be separate or distinct from the ligament anatomic simulacra 100. The reinforcement areas 124 may be formed substantially simultaneously with the ligament anatomic simulacra 100 and may not be adhered to or otherwise discretely coupled to the ligament anatomic simulacra 100. Thus, the reinforcement areas 124 and the ligament anatomic simulacra 100 may be monolithic or one-piece.

In this regard, each of the reinforcement areas 124 may comprise a portion of the ligament anatomic simulacra 100 that has at least one of a different material, a different material characteristic or combinations thereof to strengthen a portion of the ligament anatomic simulacra 100 about each of the bores 122. Generally, each of the reinforcement areas 124 are integrally formed with the ligament anatomic simulacra 100 so as to have a first reinforcement surface 128 that conforms with or matches a contour of the first surface 114. The reinforcement areas 124 may also have a second reinforcement surface 129 opposite the first reinforcement surface 128 that conforms with or matches the contour of the second surface 116. By matching the contour of the first surface 114 and the second surface 116, the reinforcement areas 124 may provide additional strength, while substantially maintaining the appearance of the portion of the anatomy the ligament anatomic simulacra 100 is simulating. In addition, the first reinforcement surface 128 and/or the second reinforcement surface 129 of the reinforcement areas 124 may include texturing, striations, or the like to replicate the portion of the anatomy the ligament anatomic simulacra 100 is simulating. Generally, each of the reinforcement areas 124 are integrally formed with the ligament anatomic simulacra 100 such that each of the first reinforcement surface 128 and the second reinforcement surface 129 reinforcement areas 124 may be flush or substantially planar with the first surface 114 and the second surface 116, respectively.

In one example, with reference to FIG. 4, each of the reinforcement areas 124 may be substantially cylindrical and may have a second diameter D2, which is different and greater than a first diameter D1 of the respective bore 122. It should be noted, however, that the reinforcement areas 124 may have any desired shape, and may comprise a polygonal area that surrounds more than one of the bores 122, if desired. Moreover, the second diameter D2 of the reinforcement areas 124 may be non-uniform such that a wall thickness T of one or more of the reinforcement areas 124 may vary. In this regard, the wall thickness T proximate or at the first reinforcement surface 128 may be different than the wall thickness T proximate or at the second reinforcement surface 129. In addition, the wall thickness T between the first reinforcement surface 128 and the second reinforcement surface 129 may be different than the wall thickness T at the first reinforcement surface 128 and the second reinforcement surface 129. Stated another way, the wall thickness T may be greater at the first reinforcement surface 128 and the second reinforcement surface 129 than a remainder of the reinforcement areas 124. Further, the wall thickness T may vary along the longitudinal axis L.

In one example, each of the reinforcement areas 124 may comprise the same material as a remainder of the ligament anatomic simulacra 100 but may have a material characteristic that may be different than a material characteristic of the remainder of the ligament anatomic simulacra 100. The “remainder of the ligament anatomic simulacra 100” as used herein is the portion of the ligament anatomic simulacra 100 that does not include the plurality of reinforced suture holes 120 or the portion of the ligament anatomic simulacra 100 that does not include the reinforcement areas 124 and the bores 122. The material characteristics may include, but are not limited to, a density, an additive manufacturing print pattern, a thickness, a hardness or durometer, or combinations thereof. For example, each of the reinforcement areas 124 may have a density, which may be different and greater than the remainder of the ligament anatomic simulacra 100. In another example, each of the reinforcement areas 124 may have an additive manufacturing print pattern, which may be more crosslinked than an additive manufacturing print pattern of the remainder of the ligament anatomic simulacra 100. As a further example, each of the reinforcement areas 124 may have a thickness, which is different and greater than a thickness of the remainder of the ligament anatomic simulacra 100. As yet another example, each of the reinforcement areas 124 may have a hardness or durometer, which is different and greater than a hardness or durometer of the remainder of the ligament anatomic simulacra 100. Further, each of the reinforcement areas 124 may have both a density and a durometer that are each different and greater than a density and a durometer of the remainder of the ligament anatomic simulacra 100.

In other examples, each of the reinforcement areas 124 may be composed of a first material and the ligament anatomic simulacra 100 may be composed of a second material, and the first material and the second material may be different. For example, the first material may include, but is not limited to a textile-based fiber material, non-elastomeric denser polymer-based material or the like. The second material may include, but is not limited to an elastomeric flexible polymer-based material.

In the example of the first material as a textile-based fiber material, one or more textile-based or textile fibers, which may be non-cross-linked, may be inserted during the formation of the ligament anatomic simulacra 100 to define the reinforcement areas 124 such that the reinforcement areas 124 are composed of the textile-based fiber first material, while the remainder of the ligament anatomic simulacra 100 is composed of the second material. The textile fibers may be encapsulated during the manufacture of the remainder of the ligament anatomic simulacra 100, which may strengthen the portion of the ligament anatomic simulacra 100 surrounding each of the bores 122. The textile fibers may include a urethane material or may be composed of nylon and/or polyester.

In the example of the first material as the non-elastomeric denser polymer-based material, the first material may comprise a rigid photopolymer, which may have a polymerized density of about 1.17 to about 1.18 grams per cubic centimeter. In this example, the first material may also have a tensile strength of about 50 megapascal to about 65 megapascal, a modulus of elasticity of about 2,000 megapascal to about 3,000 megapascal, a Shore hardness of about 83 to about 86 (Scale D), and an elongation at break of about 10 percent to 25 percent.

In the example of the second material as the elastomeric flexible polymer-based material, the second material may comprise an elastomeric photopolymer, which may have a polymerized density of about 1.14 to about 1.15 grams per cubic centimeter. In this example, the second material may also have a tensile strength of about 2.4 megapascal to about 3.1 megapascal, a Shore hardness of about 30 to about 35 (Scale A), and an elongation at break of about 220 percent to 270 percent.

Generally, with reference back to FIG. 2, each of the reinforcement areas 124 may have a tear strength, which may inhibit the tearing of the associated one of the bores 122 during the surgical training procedure. In one example, each of the tear strengths of the reinforcement areas 124 may be substantially the same. It should be noted, however, that the reinforcement area 124 associated with each of the bores 122 may be different such that each reinforcement area 124 associated with the ligament anatomic simulacra 100 may have a different tear strength. This may be desired to conform to anatomy in the field, or to provide additional surgical training. For example, a reinforcement area 124a may have a first tear strength, which may be different and greater than a second tear strength of a reinforcement area 124b. Similarly, a reinforcement area 124c may have a third tear strength that may be different and less than the first tear strength of the reinforcement area 124a and the second tear strength of the reinforcement area 124b. In other examples, the second tear strength and the third tear strength may be substantially the same, and different and less than the first tear strength.

In one example, in order to employ the ligament anatomic simulacra 100 in a surgical training procedure, such as a suturing training procedure, the ligament anatomic simulacra 100 may be manufactured to simulate a predetermined tissue of an anatomy, such as a ligament associated with a human anatomy. For example, the ligament anatomic simulacra 100 may be additively manufactured, via 3D printing, and the reinforcement areas 124 may be printed with the at least one material characteristic or material that is different than the remainder of the ligament anatomic simulacra 100. Generally, each of the first bone anatomic simulacra 102 and the second bone anatomic simulacra 104 may be formed separately from the ligament anatomic simulacra 100, via additive manufacturing, for example.

With the ligament anatomic simulacra 100 formed such that the respective reinforcement areas 124 substantially surround the respective one of the bores 122, the second end 108 of the ligament anatomic simulacra 100 may be coupled or attached to the second bone anatomic simulacra 104. In one example, the second end 108 may be coupled to the second bone anatomic simulacra 104 via ultrasonic welding, melting, adhesives, or the like. With the ligament anatomic simulacra 100 coupled to the second bone anatomic simulacra 104, the first end 106 may be detached or uncoupled from the first bone anatomic simulacra 102 such that a trainee may reattach the first end 106 of the ligament anatomic simulacra 100 to the first bone anatomic simulacra 102 to perform the surgical training procedure.

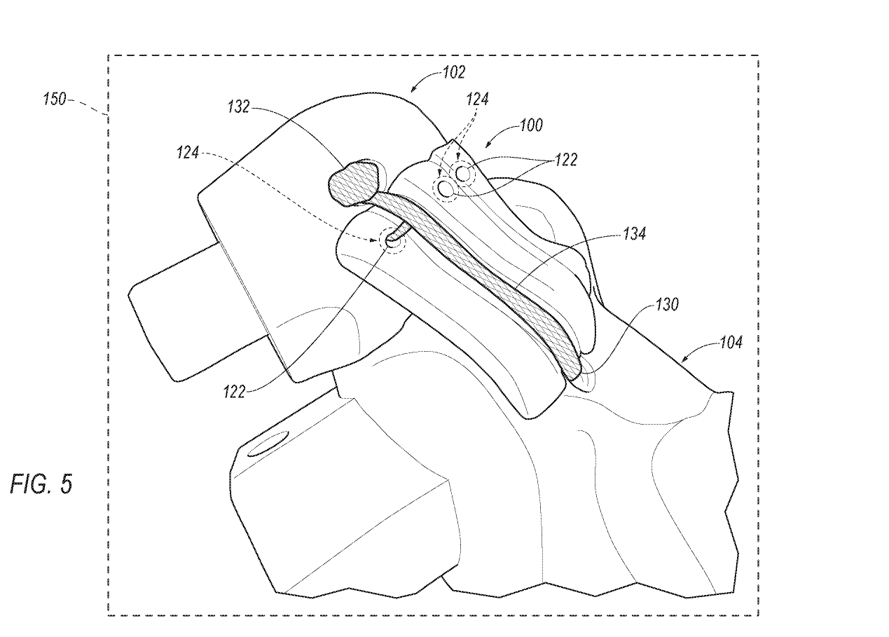

In one example, with reference to FIG. 5, the trainee may use a suitable surgical device 32, such as a drill, to form a bore 130 in the second bone anatomic simulacra 104 proximate the second end 108 of the ligament anatomic simulacra 100. The trainee may form a second bore 132 in the first bone anatomic simulacra 102 proximate where the first end 106 of the ligament anatomic simulacra 100 would be upon attachment. The trainee may use at least one flexible strand or suture 134 to couple the ligament anatomic simulacra 100 to the first bone anatomic simulacra 102. In one example, the suture 134 may couple the ligament anatomic simulacra 100 to the first bone anatomic simulacra 102 and may be applied by the trainee using a suitable suturing technique, such as a vertical suturing technique. The reinforcement areas 124 substantially surrounding the bores 122 may enable the trainee to perform numerous suturing techniques without damaging the bores 122, which may provide the trainee with the opportunity to learn and improve their suturing technique without requiring a replacement of the ligament anatomic simulacra 100. In one example, a kit 150 may include the ligament anatomic simulacra 100, the first bone anatomic simulacra 102, the second bone anatomic simulacra 104 and optionally the suture 134, the surgical instruments, such as the drill, a suture passer, etc., to enable the trainee to perform or practice the surgical training procedure.

Thus, the ligament anatomic simulacra 100 may permit the performance of a surgical training procedure, such as a suturing procedure, which may allow the trainee to perform the surgical training procedure numerous times without requiring a replacement of the ligament anatomic simulacra 100. In addition, by providing the reinforcement areas 124 with predetermined tear strengths, the ligament anatomic simulacra 100 may be manufactured to withstand the strength of various sutures. Further, by providing the reinforcement areas 124 with predetermined tear strengths, the ligament anatomic simulacra 100 may be manufactured to correspond to various anatomical structures.

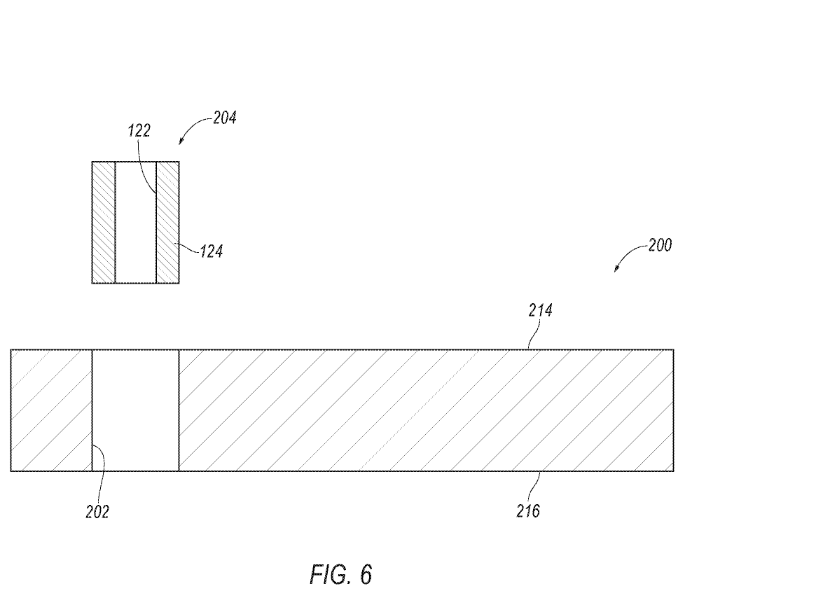

It should be noted that while the reinforcement areas 124 have been described and illustrated herein as being integrally formed with the ligament anatomic simulacra 100 to surround the bores 122, in other examples, the ligament anatomic simulacra 100 may be manufactured differently. For example, with reference to FIG. 6, a cross-section of the anatomic simulacra 200 is shown. As the anatomic simulacra 200 may be substantially the same or the same as the ligament anatomic simulacra 100, the differences between the anatomic simulacra 200 and the ligament anatomic simulacra 100 will be discussed in detail herein.

In the example of FIG. 6, the anatomic simulacra 200 may be manufactured to include insert holes 202. The insert holes 202 may be sized and shaped to receive an insert 204. The insert holes 202 may be defined through the anatomic simulacra 200 from a first surface 214 to a second surface 216. The insert 204 may comprise one of the plurality of reinforced suture holes 120. Stated another way, the insert 204 may comprise one of the bores 122 and the respective reinforcement areas 124 associated with the bore 122. Thus, in the example of FIG. 6, one or more of the plurality of reinforced suture holes 120 may be removable and replaceable so that in the instance the insert 204 may be damaged, the insert 204 may be replaced without replacing the remainder of the anatomic simulacra 200.

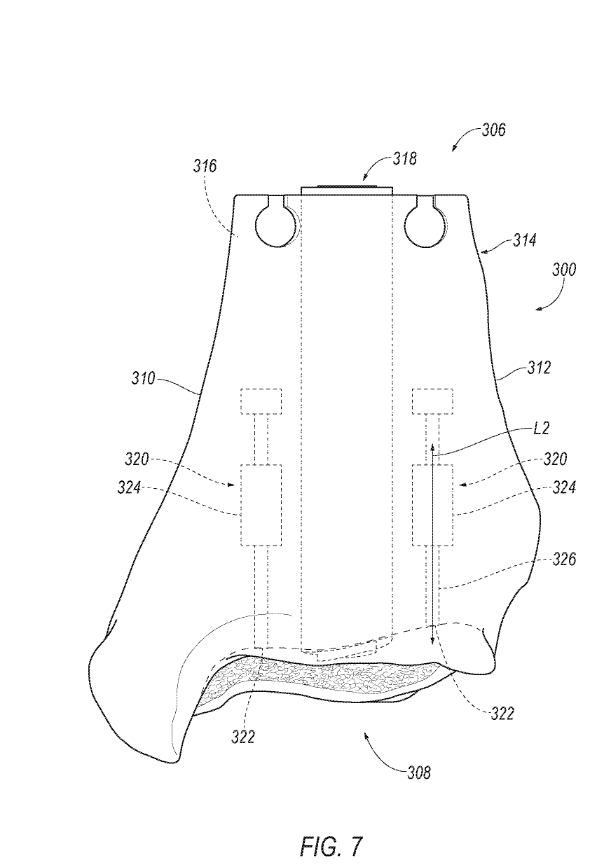

It should be noted in that an anatomic simulacra may be configured differently with one or more reinforcement areas for a particular surgical procedure. For example, with reference to FIG. 7, the anatomic simulacra 300 is shown. In this example, the anatomic simulacra 300 may be an anatomical synthetic specimen of a portion of a human or animal anatomy, such as a portion of a tibia. In one example, the anatomic simulacra 300 may be used in the place of a cadaveric specimen. The anatomic simulacra 300 may be used to practice a surgical technique, such as the insertion of a tibiotalocalcaneal nail. The anatomic simulacra 300 may be constructed using additive manufacturing techniques and systems, such as three-dimensional (3D) printing. In other examples, the anatomic simulacra 300 or portions thereof may be cast. Thus, it should be understood that other manufacturing processes, including other additive manufacturing (AM) techniques, may be employed to form the anatomic simulacra 300.

In one example, the anatomic simulacra 300 may be formed using vat photopolymerization (VPP). The anatomic simulacra 300 may be composed of a predetermined mixture of polymer-based materials, and the anatomic simulacra 300 may be constructed with predetermined fill patterns or densities to have different characteristics to simulate different human or animal anatomical structures. In one example, the anatomic simulacra 300 may be composed of suitable polymer-based materials, including, but not limited to silicon, urethane, photopolymer resins, etc.

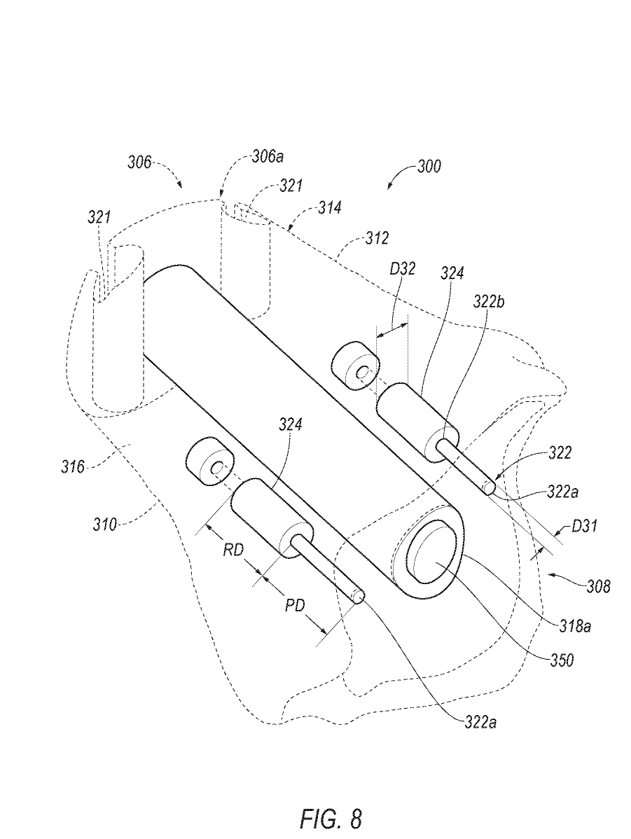

In this example, the anatomic simulacra 300 may comprise a first, proximal end 306 opposite a second, distal end 308, a first side 310 opposite a second side 312, a first surface 314 opposite a second surface 316, a canal 318 and at least one or a plurality of reinforced holes 320. With reference to FIG. 8, the proximal end 306 may include an attachment structure 306a. The attachment structure 306a may assist in coupling the anatomic simulacra 300 to a fixture for performing the surgical training procedure. In one example, the attachment structure 306a may include at least one or a pair of slots 321, which may mate with corresponding rails, bars or the like of the fixture. It should be noted that the proximal end 306 may include any suitable system for coupling the anatomic simulacra 300 to a fixture for the performance of the surgical training procedure, and the use of the attachment structure 306a is an example. The proximal end 306 may also include identification information with regard to the anatomic simulacra 300 such as a name of the manufacturer, characteristics of the anatomic simulacra 300 and the like. The canal 318 may terminate at the proximal end 306.

The first side 310, the second side 312, the first surface 314 and the second surface 316 may interconnect the proximal end 306 and distal end 308. The first side 310, the second side 312, the first surface 314 and the second surface 316 may cooperate to simulate an exterior surface of the portion of the tibia simulated by the anatomic simulacra 300. The distal end 308 may define an opening 318a associated with the canal 318 and the reinforced holes 320. The distal end 308 may include a texture or the like to simulate the distal end of the tibia.

The canal 318 may be defined substantially in a central location of the anatomic simulacra 300 to simulate the location of a medullary canal in a tibia. The opening 318a may be defined through the distal end 308 to provide access to the canal 318 for surgical training. The canal 318 may be generally cylindrical and hollow, and may be formed during the additive manufacture of the anatomic simulacra 300. The canal 318 may extend from the distal end 308 to the proximal end 306. In one example, an intermedullary implant, such as the tibiotalocalcaneal nail 350, may be received through the opening 318a and into the canal 318 to simulate the repair of an ankle joint.

In one example, the reinforced holes 320 may be defined on opposed sides of the canal 318. For example, one of the reinforced holes 320 may be defined through the distal end 308 so as to be proximate the first side 310, and another one of the reinforced holes 320 may be defined through the distal end 308 so as to be proximate the second side 312. In this example, the reinforced holes 320 may be used to introduce surgical devices 32, such as a guide wire, for example a K-wire, into the anatomic simulacra 300 to simulate the repair of the ankle joint. The reinforced holes 320 may define a bore 322 and a reinforcement area 324. In this example, the reinforcement area 324 may be defined at a terminal end of the bore 322 to provide strength to the bore 322 during the surgical training procedure. The reinforcement area 324 may enable multiple surgical training procedures to be performed without requiring replacement of the anatomic simulacra 300.

In this example, each bore 322 is defined or formed in the anatomic simulacra 300 during the additive manufacture of the anatomic simulacra 300. Each of the bores 322 may be circular and may be defined with a bore opening 322a at the distal end 308 and to extend from the bore opening 322a at the distal end 308 toward the proximal end 306 for a predetermined distance PD. It should be noted that while the bores 322 may be illustrated herein as being substantially circular, the bores 322 may not be uniform and may have any predetermined polygonal shape. For example, with reference back to FIG. 7, one or more of the bores 322 may have a diameter that varies along a central or longitudinal axis L2 of the bore 322. In other examples, a sidewall 326 of one or more of the bores 322 may be non-uniform and may include a draft angle or the like at or proximate the reinforcement area 324. In other examples, the sidewall 326 may be wavy, include protuberances, or be angled relative to the longitudinal axis L2. Thus, generally, while illustrated herein as being substantially circular, one or more of the bores 322 may have any predetermined shape. In addition, one of the bores 322 associated with the anatomic simulacra 300 may be different from the other bore 322, and may have a different sidewall 326, a different shape, a different predetermined distance PD, etc. to conform the anatomic simulacra 300 to the portion of the anatomy the anatomic simulacra 300 is simulating.

One or both of the bores 322 may be defined using the guide wire to enable the trainee to practice the insertion of the guide wire. In the example of one or both of the bores 322 being formed with the guide wire during the surgical training procedure, the bores 322 may be composed of a material that is substantially the same as the material of anatomic simulacra 300 outside of the reinforcement area 324.

Generally, the reinforcement area 324 may blend into the material of the anatomic simulacra 300. Stated another way, the reinforcement areas 324 may be integrally formed with or additively manufactured with the anatomic simulacra 300 and may not be separate or distinct from the anatomic simulacra 300. The reinforcement areas 324 may be formed substantially simultaneously with the anatomic simulacra 300 and may not be adhered to or otherwise discretely coupled to the anatomic simulacra 300. Thus, the reinforcement areas 324 and the anatomic simulacra 300 may be monolithic or one-piece.

In this example, the reinforcement area 324 may be defined to extend from an internal terminal end 322b of each of the bores 322 for a predetermined reinforcement distance RD. The reinforcement distance RD may generally be defined to receive or accommodate an end of the guide wire.

Each of the reinforcement areas 324 may comprise a portion of the anatomic simulacra 300 that has at least one of a different material, a different material characteristic or combinations thereof to strengthen a portion of the anatomic simulacra 300 proximate or directly adjacent to each of the bores 322. Generally, each of the reinforcement areas 324 are integrally formed with the anatomic simulacra 300 so as to conform with or match a contour of the anatomic simulacra 300. By matching the conforming with the anatomic simulacra 300, the reinforcement areas 324 may provide additional stability while substantially maintaining the appearance of the portion of the anatomy the anatomic simulacra 300 is simulating.

In one example, with reference to FIG. 8, each of the reinforcement areas 324 may be substantially cylindrical and may have a second diameter D32, which is different and greater than a first diameter D31 of the respective bore 322. It should be noted, however, that the reinforcement areas 324 may have any desired shape, and may comprise a polygonal area that is associated with more than one of the bores 322, if desired. Moreover, the second diameter D32 of the reinforcement areas 324 may be non-uniform such that a wall thickness of one or more of the reinforcement areas 324 may vary.

In one example, the reinforcement areas 324 may be composed of the second material and the remainder of the anatomic simulacra 300 may be composed of the first material, as described previously herein. The “remainder of the anatomic simulacra 300” as used herein is the portion of the anatomic simulacra 300 that does not include the reinforced holes 320 or the portion of the anatomic simulacra 300 that does not include the reinforcement areas 324 and the bores 322. By providing the reinforcement areas 324 composed of the second material, the reinforcement area 324 may provide additional stability and resistance during the insertion of the surgical devices 32 or the guidewire to simulate the surgical procedure.

In other examples, the reinforcement areas 324 may comprise the same material as a remainder of the anatomic simulacra 300 but may have a material characteristic that may be different than a material characteristic of the remainder of the anatomic simulacra 300. The material characteristics may include, but are not limited to, a density, an additive manufacturing print pattern, a thickness, a hardness or durometer, or combinations thereof. For example, each of the reinforcement areas 324 may have a density, which may be different and less than the remainder of the anatomic simulacra 300. In another example, each of the reinforcement areas 324 may have an additive manufacturing print pattern, which may be less crosslinked than an additive manufacturing print pattern of the remainder of the anatomic simulacra 300. As a further example, each of the reinforcement areas 324 may have a thickness, which is different and less than a thickness of the remainder of the anatomic simulacra 300. As yet another example, each of the reinforcement areas 324 may have a hardness or durometer, which is different and less than a hardness or durometer of the remainder of the anatomic simulacra 300. Further, each of the reinforcement areas 324 may have both a density and a durometer that are each different and less than a density and a durometer of the remainder of the anatomic simulacra 300.

Thus, the anatomic simulacra 300 may permit the performance of a surgical training procedure, such as an ankle joint repair, which allows the trainee to perform the surgical training procedure numerous times without requiring a replacement of the anatomic simulacra 300.

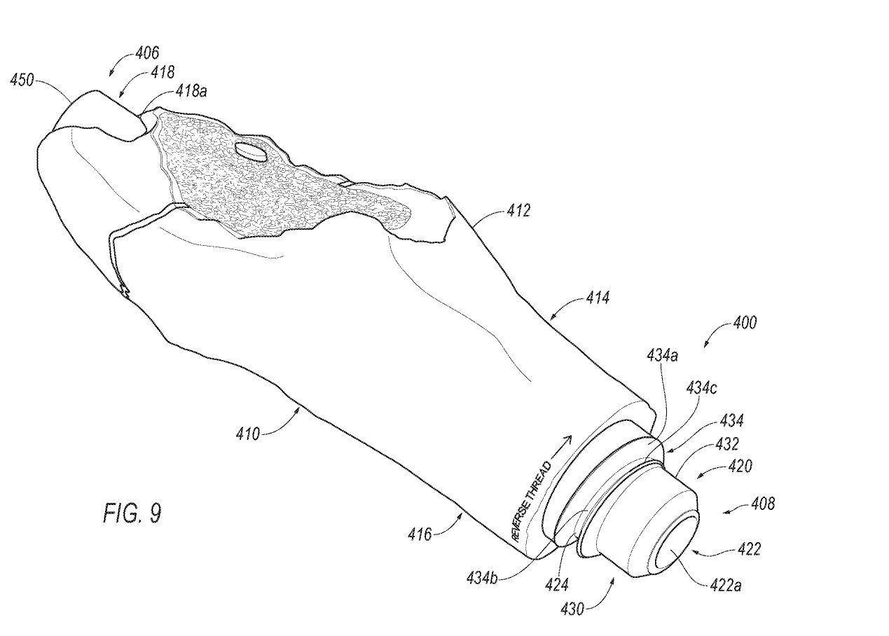

It should be noted in that an anatomic simulacra may be configured differently with one or more reinforcement areas for a particular surgical procedure. For example, with reference to FIG. 9, an anatomic simulacra 400 is shown. In this example, the anatomic simulacra 400 may be an anatomical synthetic specimen of a portion of a human or animal anatomy, such as a portion of a femur. In one example, the anatomic simulacra 400 may be used in the place of a cadaveric specimen. The anatomic simulacra 400 may be used to practice a surgical technique, such as the insertion of a trochanteric nail. The anatomic simulacra 400 may be constructed using additive manufacturing techniques and systems, such as three-dimensional (3D) printing. In other examples, the anatomic simulacra 400 or portions thereof may be cast. Thus, it should be understood that other manufacturing processes, including other additive manufacturing (AM) techniques, may be employed to form the anatomic simulacra 400.

In one example, the anatomic simulacra 400 may be formed using vat photopolymerization (VPP). The anatomic simulacra 400 may be composed of a predetermined mixture of polymer-based materials, and the anatomic simulacra 400 may be constructed with predetermined fill patterns or densities to have different characteristics to simulate different human or animal anatomical structures. In one example, the anatomic simulacra 400 may be composed of suitable polymer-based materials, including, but not limited to silicon, urethane, photopolymer resins, etc.

In this example, the anatomic simulacra 400 may comprise a first, proximal end 406 opposite a second, distal end 408, a first side 410 opposite a second side 412, a first surface 414 opposite a second surface 416, a canal 418 and at least one reinforced hole 420. The proximal end 406 may define an opening 418a associated with the canal 418. The proximal end 406 may include a texture or the like to simulate the proximal end of the femur.

The first side 410, the second side 412, the first surface 414 and the second surface 416 may interconnect the proximal end 406 and the distal end 408. The first side 410, the second side 412, the first surface 414 and the second surface 416 may cooperate to simulate an exterior surface of the portion of the femur simulated by the anatomic simulacra 400. In this example, the first side 410 may include a simulated fracture, and the second side 412 may include a simulated fracture of a femoral neck.

The distal end 408 may include the reinforced hole 420. In this example, the reinforced hole 420 may be defined through an attachment portion 430 of the anatomic simulacra 400. The attachment portion 430 may assist in coupling the anatomic simulacra 400 to a fixture or another anatomic simulacra for performing the surgical training procedure. In one example, the attachment portion 430 may extend outwardly from the distal end 408, and the reinforced hole 420 may be defined through the attachment portion 430 so as to be in communication with the canal 418. In one example, an exterior surface 432 of the attachment portion 430 may include a thread 434, such as a reverse thread, for example, to assist in coupling the anatomic simulacra 400 to a fixture or to another anatomic simulacra.

The reinforced hole 420 may define a bore 422 that extends through the attachment portion 430 and a reinforcement area 424. The thread 434 may surround about a portion of a perimeter of the bore 422. In this example, the bore 422 is defined or formed in the anatomic simulacra 400 during the additive manufacture of the anatomic simulacra 400. The bore 422 may be circular and may be defined with a bore opening 422a at the distal end 408 and the bore 422 may be in communication with the canal 418. It should be noted that while the bore 422 may be illustrated herein as being substantially circular, the bore 422 may not be uniform and may have any predetermined polygonal shape.

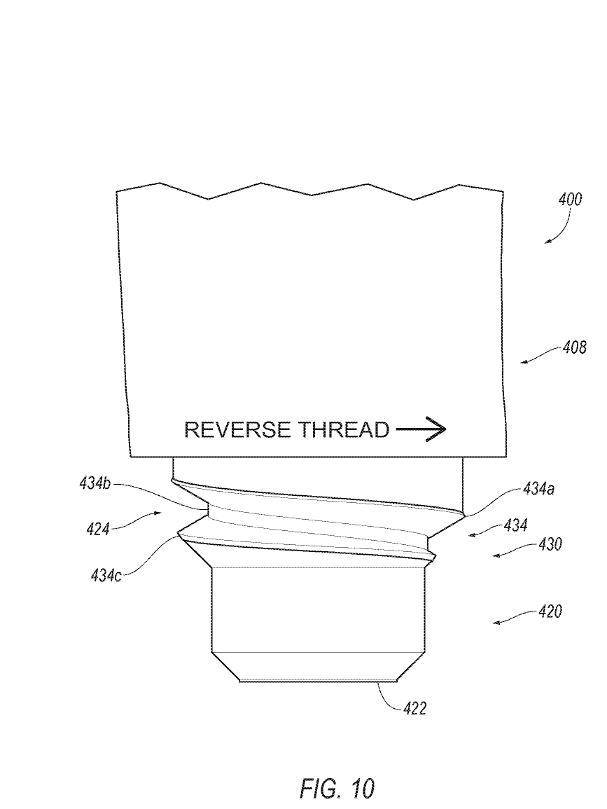

In this example, the reinforcement area 424 may be defined as the thread 434 to surround or circumscribe a portion of the bore 422. Stated another way, with reference to FIG. 10, the reinforcement area 424 may be defined along a first thread surface 434a, a second thread surface 434b and a third thread surface 434c such that a contact surface of the thread 434 is formed by the reinforcement area 424. By providing the reinforcement area 424 about a portion of a perimeter of the bore 422, the reinforcement area 424 may provide resistance and stability to the bore 422 when coupling the anatomic simulacra 400 to the fixture or to another anatomic simulacra.

Generally, the reinforcement area 424 may blend into the material of the anatomic simulacra 400. Stated another way, the reinforcement areas 424 may be integrally formed with or additively manufactured with the anatomic simulacra 400 and may not be separate or distinct from the anatomic simulacra 400. The reinforcement areas 424 may be formed substantially simultaneously with the anatomic simulacra 400 and may not be adhered to or otherwise discretely coupled to the anatomic simulacra 400. Thus, the reinforcement areas 424 and the anatomic simulacra 400 may be monolithic or one-piece.

In this example, the reinforcement area 424 may be defined along the thread 434 to provide additional resistance and stability to the attachment portion 430 and the bore 422 defined in the attachment portion 430. The reinforcement area 424 may comprise a portion of the anatomic simulacra 400 that has at least one of a different material, a different material characteristic or combinations thereof to strengthen a portion of the anatomic simulacra 400 proximate or adjacent the bore 422. In one example, the reinforcement area 424 may be composed of the second material and the remainder of the attachment portion 430 of the anatomic simulacra 400 may be composed of the first material, as described previously herein. Generally, the reinforcement area 424 is integrally formed with the anatomic simulacra 400 so as to conform with or match a contour of the anatomic simulacra 400. By matching the conforming with the anatomic simulacra 400, the reinforcement areas 424 may provide additional stability while substantially maintaining the appearance of the anatomic simulacra 400.

In other examples, the reinforcement areas 424 may comprise the same material as a remainder of the anatomic simulacra 400 but may have a material characteristic that may be different than a material characteristic of the remainder of the anatomic simulacra 400. The material characteristics may include, but are not limited to, a density, an additive manufacturing print pattern, a thickness, a hardness or durometer, or combinations thereof. For example, each of the reinforcement area 424 may have a density, which may be different than the remainder of the anatomic simulacra 400. In another example, each of the reinforcement area 424 may have an additive manufacturing print pattern, which may be different than an additive manufacturing print pattern of the remainder of the anatomic simulacra 400. As a further example, each of the reinforcement area 424 may have a thickness, which is different than a thickness of the remainder of the anatomic simulacra 400. As yet another example, each of the reinforcement area 424 may have a hardness or durometer, which is different than a hardness or durometer of the remainder of the anatomic simulacra 400. Further, each of the reinforcement area 424 may have both a density and a durometer that are each different than a density and a durometer of the remainder of the anatomic simulacra 400.

The distal end 408 may also include identification information with regard to the anatomic simulacra 400 such as a name of the manufacturer, characteristics of the anatomic simulacra 400 and the like. The canal 418 may terminate at the opening 422a of the bore 422 defined in the distal end 408.

With reference back to FIG. 9, the canal 418 may be defined substantially in a central location of the anatomic simulacra 400 to simulate the location of a medullary canal in a femur. The opening 418a may be defined through the proximal end 406 to provide access to the canal 418 for a surgical training procedure. The canal 418 may be generally cylindrical and hollow and may be formed during the additive manufacture of the anatomic simulacra 400. The canal 418 may extend from the proximal end 406 to the distal end 408. In one example, an intermedullary implant, such as a trochanteric nail 450, may be received through the opening 418a and into the canal 418 to simulate the repair of a hip joint.

Thus, the anatomic simulacra 400 may permit the performance of a surgical training procedure, such as a hip joint repair, which allows the trainee to perform the surgical training procedure numerous times without requiring a replacement of the anatomic simulacra 400.

It should be note that the geometry and material properties for each of the ligament anatomic simulacra 100, the first bone anatomic simulacra 102, the second bone anatomic simulacra 104, the anatomic simulacra 300 and the anatomic simulacra 400 illustrated and described herein may be obtained through imaging data, such as by way of example, MRI (magnetic resonance imaging) or CT (computed tomography) scans, among others. Therefore, one or more of the ligament anatomic simulacra 100, the first bone anatomic simulacra 102, the second bone anatomic simulacra 104, the anatomic simulacra 300 and the anatomic simulacra 400 may be configured to simulate the anatomy of an actual patient, thus providing more accurate specimens for surgical planning and preparation. As a result, more positive outcomes may be possible in surgical procedures through the use of the ligament anatomic simulacra 100, the first bone anatomic simulacra 102, the second bone anatomic simulacra 104, the anatomic simulacra 300 and the anatomic simulacra 400 set forth herein.

It should be noted that in certain forms, the anatomic simulacra 10, such as the ligament anatomic simulacra 100, the first bone anatomic simulacra 102, the second bone anatomic simulacra 104, the anatomic simulacra 300 and/or the anatomic simulacra 400, may be in communication with one or more of the surgical suite 20 and the robot 27 to transmit and receive data, power, etc.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “about” denotes within 15% to account for manufacturing tolerances. In addition, the term “substantially” denotes within 15% to account for manufacturing tolerances.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An anatomic simulacra, comprising:
at least one reinforced hole defined through the anatomic simulacra, the at least one reinforced hole including a bore and a reinforcement area proximate the bore.

2. The anatomic simulacra of claim 1, wherein the anatomic simulacra is a polymer-based synthetic ligament, muscle or tendon.

3. The anatomic simulacra of claim 1, wherein the at least one reinforced hole comprises a plurality of reinforced suture holes, which are defined through the anatomic simulacra to extend from a first surface to a second surface.

4. The anatomic simulacra of claim 1, wherein the reinforcement area includes at least one of a material characteristic, a material or combinations thereof that is different than a remainder of the anatomic simulacra.

5. The anatomic simulacra of claim 4, wherein the material characteristic is at least one of a density, an additive manufacturing print pattern, a durometer and a thickness.

6. The anatomic simulacra of claim 4, wherein the material is a textile fiber reinforcement.

7. The anatomic simulacra of claim 4, wherein the material is a non-elastomeric polymer-based material.

8. The anatomic simulacra of claim 4, wherein the material is an elastomeric polymer-based material.

9. The anatomic simulacra of claim 1, wherein the anatomic simulacra is additively manufactured, and the reinforcement area is integrally formed with the anatomic simulacra.

10. The anatomic simulacra of claim 1, wherein the at least one reinforced hole is discretely formed and coupled to the anatomic simulacra.

11. The anatomic simulacra of claim 1, wherein the reinforcement area is defined about at least a portion of a perimeter of the bore.

12. The anatomic simulacra of claim 1, wherein the anatomic simulacra include an external thread, and the reinforcement area is defined within at least a portion of the thread to surround at least a portion of the bore.

13. The anatomic simulacra of claim 1, wherein the reinforcement area is defined at a terminal end of the bore.

14. A kit for performing a surgical training procedure, comprising:
at least one ligament anatomic simulacra having a first end opposite a second end and a first surface opposite a second surface, the at least one ligament anatomic simulacra defining at least one reinforced hole through the first surface and the second surface; and
a bone anatomic simulacra configured to be coupled to the at least one ligament anatomic simulacra with the at least one reinforced hole.

15. The kit of claim 14, further comprising a second bone anatomic simulacra that cooperates with the bone anatomic simulacra to form a synthetic anatomical joint, the at least one ligament anatomic simulacra is coupled to the second bone anatomic simulacra at the second end, the at least one reinforced hole is defined proximate the first end and a suture is configured to couple the first end of the at least one ligament anatomic simulacra to the bone anatomic simulacra.

16. The kit of claim 14, wherein the at least one ligament anatomic simulacra is a polymer-based synthetic ligament, muscle or tendon, and the at least one ligament anatomic simulacra is additively manufactured.

17. The kit of claim 16, wherein the at least one reinforced hole comprises a bore and a reinforcement area substantially surrounding the bore, and the reinforcement area is integrally formed with the at least one ligament anatomic simulacra.

18. The kit of claim 17, wherein the reinforcement area includes at least one of a material characteristic, a material or combinations thereof that is different than a remainder of the at least one ligament anatomic simulacra.

19. The kit of claim 18, wherein the material characteristic is at least one of a density, an additive manufacturing print pattern, a durometer and a thickness.

20. The kit of claim 18, wherein the material is a textile fiber reinforcement or a non-elastomeric polymer-based material.
